(19) United States
(12) Patent Application Publication
(10) Pub. No.: US 2017/0061608 A1
(43) Pub. Date: Mar. 2, 2017

(54) CLOUD-BASED PATHOLOGICAL ANALYSIS SYSTEM AND METHOD

(71) Applicant: LUNIT INC., Seoul (KR)

(72) Inventors: Hyo-eun KIM, Seoul (KR); Sang-heum HWANG, Seoul (KR); Seung-wook PAEK, Seoul (KR); Jung-in LEE, Seoul (KR); Min-hong JANG, Seoul (KR); Dong-geun YOO, Daejeon (KR); Kyung-hyun PAENG, Busan (KR); Sung-gyun PARK, Icheon-si, Gyeonggi-do (KR)

(73) Assignee: Lunit Inc., Seoul (KR)

(21) Appl. No.: 15/113,680

(22) PCT Filed: Sep. 9, 2015
(86) PCT No.: PCT/KR2015/009484

§ 371 Date: Jul. 22, 2016

(30) Foreign Application Priority Data
Apr. 20, 2015 (KR) 10-2015-0055167

(51) Int. Cl. G06T 7/00; H04L 29/06; G06F 17/30; H04L 29/08

(52) U.S. Cl. CPC G06T 7/0012; H04L 67/10; H04L 67/42; G06F 17/3028; G06F 17/30256; G06T 2207/30024; G06T 2207/10056

(57) ABSTRACT

The present invention relates to a cloud-based pathological analysis system and method. The present invention provides a cloud-based pathological analysis system, including: a client device coupled to a microscope, and configured to acquire an image for a tissue sample via the microscope and generate a sample image; and a cloud server coupled to the client device over a network, and configured to receive sample image data from the client device over the network and store the sample image data; wherein the cloud server analyzes the received sample image data, and transmits analysis information to the client device.

### TECHNICAL FIELD

The present invention relates to a cloud-based pathological analysis system and method, and more particularly to a system and method that are capable of conveniently and efficiently providing pathological analysis based on a cloud online.

### BACKGROUND ART

Pathology is a medical field in which whether an abnormality is present is determined by examining a tissue sample with the naked eye or a microscope and then analyzing the results of the examination. For example, in order to diagnose cancer, a pathologist makes a diagnosis of cancer by examining a tissue sample of a corresponding suspected tissue via a microscope and then determining whether cancer cells are present.

In such conventional pathologic diagnosis, a medical scanner, a microscopic camera, etc. are used. Since these devices must scan a tissue sample at ultra-high resolution and process the scanned image, the devices are considerably expensive devices and, thus, have difficulty in their use in an actual site.

Furthermore, since these devices perform an ultra-high resolution task, the devices generate an image having a size ranging from hundreds of megabytes to a few gigabytes for a single tissue sample, and this requires a considerably long period of time.

Meanwhile, with the recent development of IT technology, small-sized devices, such as a smartphone, a tablet PC, etc., are each equipped with a high-performance computation unit (a CPU or a GPU) and large-capacity memory, and a camera or a network interface also includes considerably high-performance resources.

Accordingly, there is a demand for a method for performing pathologic diagnosis using a small-sized mobile device, such as a smartphone.

As such a method, Korean Patent Application Publication No. 10-2006-0128285 (published on Dec. 14, 2006) discloses “Naked Eye-based Pathological Tissue Photo Photographing System using Digital Camera.” This technology is characterized in that a control board is provided between a digital camera and a computer so that a pathologist can directly and conveniently photograph and store a naked eye-based pathological tissue photo using a digital camera, a pathological number recorded in the form of a barcode can be recognized, and then an image can be displayed and photographed using the digital camera.

However, this technology is configured to merely photograph a tissue sample and store an image of the tissue sample using the digital camera, and is limited in that the image of the tissue sample cannot be analyzed or organized into a database and the tissue sample cannot be analyzed and diagnosed regardless of time and location through sharing with another human or system.

### PRECEDING TECHNICAL DOCUMENT

(Patent Document 1) Korean Patent Application Publication No. 10-2006-0128285 (published on Dec. 14, 2006)

### DISCLOSURE

### Technical Problem

The present invention is intended to overcome the above-described limitations, and an object of the present invention is to provide a system and method that are capable of conveniently and efficiently providing pathological analysis based on a cloud online.

Furthermore, another object of the present invention is to provide a system and method that are capable of acquiring an image of a tissue sample using a relatively inexpensive, small-sized mobile client device, organizing the image into a database in a cloud system over a network, and classifying and analyzing the sample image using a training engine, thereby providing the analysis information of the tissue sample to the client device.

Furthermore, still another object of the present invention is to provide a system and method that are capable of organizing additional information, such the analysis information of a pathologist, together with an image of a tissue sample, into a database, thereby improving accuracy of analysis and also enabling related information to be shared with and referred to by third persons regardless of time and location.

Furthermore, still another object of the present invention is to provide a system and method that are capable of enabling a client device to access a cloud server over a network, thereby enabling both a sample image and various types of related tag information to be referred to and also enabling additional information to be recorded.

### Technical Solution

In order to accomplish the above objects, the present invention provides a cloud-based pathological analysis system, including: a client device coupled to a microscope, and configured to acquire an image for a tissue sample via the microscope and generate a sample image; and a cloud server coupled to the client device over a network, and configured to receive sample image data from the client device over the network and store the sample image data; wherein the cloud server analyzes the received sample image data, and transmits analysis information to the client device.

In this case, the client device may include: an image acquisition unit configured to acquire the sample image by acquiring the image for the tissue sample via the microscope; a communication unit configured to transmit the sample image data for the sample image to the cloud server over the network and receive the analysis information from the cloud server; and an analysis information processing unit configured to process the analysis information received from the cloud server and provide the processed analysis information to the user via a display unit.

Furthermore, the cloud-based pathological analysis system may further include a preprocessing unit configured to perform a preprocessing process on the sample image acquired by the image acquisition unit.

Furthermore, the cloud server may be configured to include: a communication unit configured to receive the sample image data from the client device over the network and transmit the result of the analysis over the network; a data management unit configured to process and manage the sample image data; an untagged image database configured to store the sample image data processed by the data management unit; a classification unit configured to determine and classify an abnormality based on the sample image data; and an analysis information generation unit configured to generate the analysis information based on the result of the classification, obtained by the classification unit, and the sample image data.

Furthermore, the classification unit may include a classification engine configured to classify the sample image data based on existing image data including the results of classification.

Furthermore, the client device may be configured to further include an additional information management unit configured to receive additional information from a user with respect to the sample image and store and manage the additional information; and the cloud server may be configured to receive the sample image data and the additional information associated with the sample image data from the client device over the network, and to store the sample image data and the additional information.

Furthermore, the communication unit of the client device may be configured to transmit the additional information, together with the sample image data for the sample image, to the cloud server over the network.

Furthermore, the communication unit of the cloud server may be configured to receive the sample image data and the additional information from the client device over the network; the data management unit of the cloud server may be configured to process and manage the sample image data and the additional information; and the cloud server may be configured to further include a tagged image database configured to store the sample image data and the additional information processed by the data management unit.

Furthermore, the client device may be configured to receive the sample image data from the untagged image database of the cloud server, to receive the additional information for the corresponding sample image data, and to transmit identification information of the sample image data and the additional information to the cloud server; and the cloud server may be configured to store the sample image data and the additional information corresponding to the identification information of the received sample image data in the tagged image database.

Furthermore, the client device may further include: an untagged image display unit configured to receive the sample image data from the untagged image database of the cloud server and to display the sample image for the received sample image data via the display unit; and an additional information management unit configured to receive the additional information from the user with respect to the displayed sample image, and to store and manage the additional information; and the communication unit may transmit a sample image data request signal to the cloud server, may receive sample image data corresponding to the request signal, may transfer the sample image data to the untagged image display unit, and may transmit identification information of the sample image data for the sample image and the additional information to the cloud server over the network.

Furthermore, the communication unit of the cloud server may be configured to receive a sample image data request signal from the client device over the network, to transmit sample image data corresponding to the request signal, and to receive identification information and additional information for the sample image data from the client device; the data management unit of the cloud server may be configured to process the sample image data and the additional information; and the tagged image database of the cloud server may be configured to store the sample image data and the additional information processed by the data management unit.

According to another aspect of the present invention, there is provided a cloud-based pathological analysis method, including: a first step of being coupled, by a client device, to a microscope, acquiring an image for a tissue sample via the microscope, and generating a sample image; a second step of receiving, by a cloud server, sample image data from the client device over a network, and storing the sample image data; and a third step of analyzing, by the cloud server, the received sample image data, and transmitting analysis information to the client device.

Furthermore, the cloud-based pathological analysis method may further comprising, after the first step, a step of acquiring, by the client device, additional information associated with the sample image; and the second step may further include receiving, by the cloud server, the sample image data and the additional information associated with the sample image data from the client device over the network, and storing the sample image data and the additional information.

Furthermore, the cloud-based pathological analysis method may further include steps of: receiving, by the client device, the sample image data from the cloud server, and receiving additional information for the corresponding sample image data; receiving, by the cloud server, identification information of the sample image data and the additional information from the client device; and storing, by the cloud server, the sample image data and the additional information corresponding to the identification information of the received sample image data.

### Advantageous Effects

According to the present invention, there may be provided a system and method that are capable of conveniently and efficiently providing pathological analysis based on a cloud online.

Furthermore, according to the present invention, there may be provided a system and method that are capable of acquiring an image of a tissue sample using a relatively inexpensive, small-sized mobile client device, organizing the image into a database in a cloud system over a network, and classifying and analyzing the sample image using a training engine, thereby conveniently and efficiently providing the analysis information of the tissue sample to the client device.

Furthermore, according to the present invention, there may be provided a system and method that are capable of organizing additional information, such the analysis information of a pathologist, together with an image of a tissue sample, into a database, thereby improving the accuracy of analysis and also enabling related information to be shared with and referred to by third persons regardless of time and location.

Furthermore, according to the present invention, there may be provided a system and method that are capable of enabling a client device to access a cloud server over a network, thereby enabling both a sample image and various types of related tag information to be referred to and also enabling additional information to be recorded.

Furthermore, according to the present invention, there is achieved an advantage of conveniently and efficiently construct a digital pathological analysis system that is capable of analyzing a tissue sample at an inexpensive cost.

### DESCRIPTION OF DRAWINGS

FIG. 1 is a diagram showing the overall configuration and connection relationships of a cloud-based pathological analysis system 100 according to the present invention;

FIG. 2 is a diagram showing the internal configuration of the client device 20;

FIG. 3 is a diagram showing the internal configuration of the cloud server 30;

FIG. 4 is a flowchart showing an embodiment of a cloud-based pathologic analysis method that is performed in the system 100 described with reference to FIGS. 1 to 3;

FIG. 5 is a diagram showing the configuration of a client device 20A;

FIG. 6 is a diagram showing the configuration of a cloud server 30A;

FIG. 7 is a flowchart showing an embodiment of the method that is performed in the system 100 described with reference to FIGS. 5 and 6;

FIG. 8 is a diagram showing the configuration of a client device 20B;

FIG. 9 is a diagram showing the configuration of a cloud server 30B; and

FIG. 10 is a flowchart showing another embodiment of the method of the present invention that is performed in the system 100 of FIGS. 8 and 9.

### BEST MODE

Embodiments of the present invention will be described in detail below with reference to the accompanying drawings.

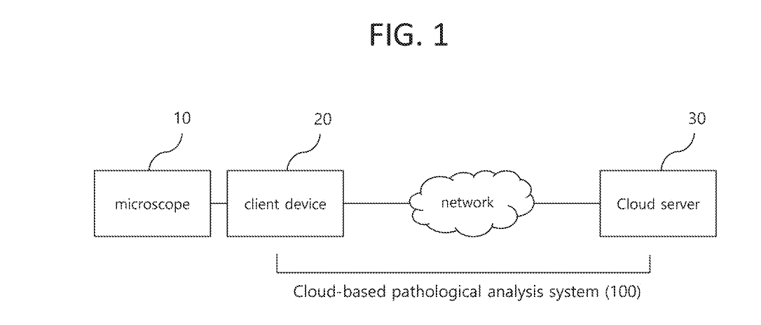

FIG. 1 is a diagram showing the overall configuration and connection relationships of a cloud-based pathological analysis system 100 according to the present invention.

Referring to FIG. 1, the cloud-based pathological analysis system 100 (hereinafter simply referred to as the “system 100”) includes a client device 20 and a cloud server 30.

The client device 20 is coupled to a microscope 10, and functions to acquire an image of a tissue sample via the microscope 10 and generate a sample image.

In this case, the client device 20 is a device, such as a smartphone or a tablet PC, and includes a photographing means, such as a camera, capable of acquiring an image, a display device capable of displaying an image, and a communication means capable of transmitting and receiving data over a network.

Meanwhile, the client device 20 is coupled to the microscope 10, and acquires an image of a tissue sample via the microscope 10. In this case, the microscope 10 refers to a general microscope 10 that is known in the conventional art and expands a tissue sample, thereby enabling a doctor to perform pathological analysis.

The client device 20 may be coupled such that the eyepiece of the microscope 10 comes into contact with the lens of the photographing means, such as a camera, provided in the client device 20. As described above, it is preferred that in order to enable the camera lens of the client device 20 and the eyepiece of the microscope 10 to come into contact with each other, a stand configured to support and fasten the client device 20 on and to the microscope 10 is provided.

Through the above coupling, the client device 20 is enabled to acquire an image of a tissue sample via the microscope 10.

The cloud server cloud server 30 is coupled to the client device 20 over a network, and functions to receive and store sample image data for a tissue sample from the client device 20 over the network, to analyze the sample image data, and to transmit analysis information to the client device 20.

In this case, the network is based on a concept that includes a general known wired or wireless communication network or a combination thereof including the Internet.

The system 100 configured as described above is chiefly characterized by operating as follows. That is, when the client device 20 acquires an image of a tissue sample via the microscope, generates sample image data for the tissue sample and transmits the sample image data to the cloud server 30, the cloud server 30 stores and analyzes the received sample image data and transmits analysis information, for example, analysis information about whether the corresponding tissue sample includes an abnormal cell, to the client device 20, and the client device 20 provides the received analysis information to a user via the display unit.

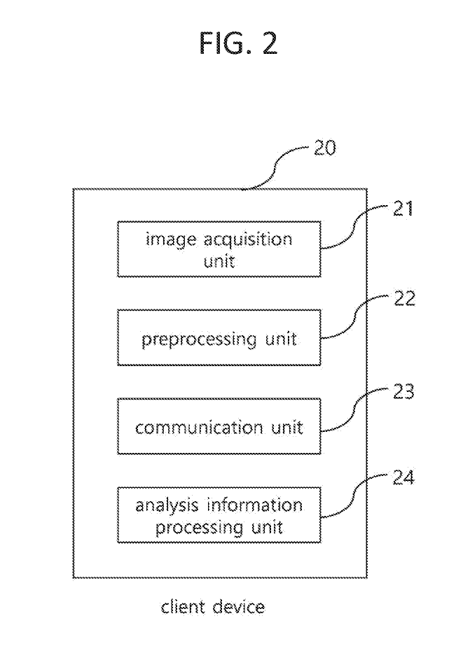

Next, the individual components will be described in greater detail below with reference to FIG. 2.

FIG. 2 is a diagram showing the internal configuration of the client device 20.

Referring to FIG. 2, the client device 20 includes an image acquisition unit 21, a preprocessing unit 22, a communication unit 23, and an analysis information processing unit 24.

The image acquisition unit 21 functions to acquire a sample image for a tissue sample via the microscope 10. In this case, the image acquisition unit 21 includes a photographing means, such as a camera, provided in the client device 20, and all hardware and software means configured to convert an image, photographed by the photographing means, into image data by processing the image. As described above, the coupling is made such that the lens of the photographing means of the client device 20 and the eyepiece of the microscope 10 come into contact with each other. Accordingly, the lens of the photographing means of the client device 20 may acquire an image via the eyepiece of the microscope 10, and the acquired image may be acquired from the image acquisition unit 21.

Meanwhile, since a microscope that is generally used to diagnose a tissue in pathology expands a minute tissue sample hundreds to thousands of times, problems arise in that an image for the overall tissue sample that can be acquired via the microscope 10 has an excessively large size and a process of acquiring the image takes an excessively long period of time.

Accordingly, it is preferred that a user identifies a region requiring precise analysis, i.e., a region of interest (ROI), with his or her eyes while manipulating the microscope 10, searches for a region where cells suspected of abnormal cells, such as cancer cells, are present, and acquires only an image of a corresponding region of interest, thereby acquiring a smaller size image within a shorter period of time than the conventional technology.

The preprocessing unit 22 is responsible for a function of performing a preprocessing process on the sample image acquired by the image acquisition unit 21. In this case, the preprocessing process refers to a process of generating data in a form that is available in the cloud server 30, and refers to a process of generating a sample image or generating additional information or the like that can be acquired from a sample image through additional analysis. The preprocessing process may include interpolation, color/gamma correction and color space conversion processes for converting the signal (raw data) of the sample image, received via, for example, a camera sensor and acquired by the image acquisition unit 21, into a high-quality color image signal (for example, YCbCr). Furthermore, the preprocessing process may include separate image processing processes for generating information, which is valid for the analysis of an image that is performed by the classification unit 34 of the cloud server 30, from the color image signal obtained through the conversion, for example, histogram equalization, image filtering, edge/contour/cell detection processes.

The preprocessing process may include a combination of a plurality of detailed steps, as desired. The preprocessing process may flexibly configure the system according to the environment (for example, hardware performance) of the client device 20 so that part or all of detailed steps can be processed by the cloud server 30. Accordingly, the preprocessing unit 22 may be omitted as desired, in which case a configuration may be made such that the omitted process can be processed by the cloud server 30.

The communication unit 23 is responsible for a function of transmitting the sample image data for the sample image, generated by the image acquisition unit 21 or preprocessing unit 22, to the cloud server 30 via a network and a function of receiving the analysis information from the cloud server 30. That is, the communication unit 23 performs a function of transmitting and receiving data to and from the cloud server 30.

The communication unit 23 may transmit the sample image data, and simultaneously may transmit other additional information, such as the location information (for example, coordinate information or the like) of the region of interest for the corresponding sample image. In this case, the other additional information may include other additional information generated through the preprocessing process of the above-described preprocessing unit 22.

The analysis information processing unit 24 functions to process the analysis information received from the cloud server 30 and to provide the processed analysis information to a user via the display unit.

In this case, the analysis information refers to information about the result of the determination of abnormality obtained through the analysis of corresponding sample image data of the cloud server 30. For example, the analysis information may include information, such as information about the presence or absence of the abnormality of each cell included in the corresponding tissue sample image, the number of abnormal cells, a probability that the cell is an abnormal cell, the location information of the abnormal cell and/or the like. The analysis information may include comprehensive information, such as information about the presence or absence of an abnormality in the corresponding tissue sample image, a probability that the corresponding tissue is an abnormality tissue and/or the like, based on the analysis information of each cell included in the corresponding tissue sample image.

The analysis information is processed into a form, which can be displayed on the display unit, through a task, such as parsing, via the analysis information processing unit 25 when required, and is displayed on the display unit, thereby enabling a user to visually become aware of the result of the analysis of the corresponding tissue sample.

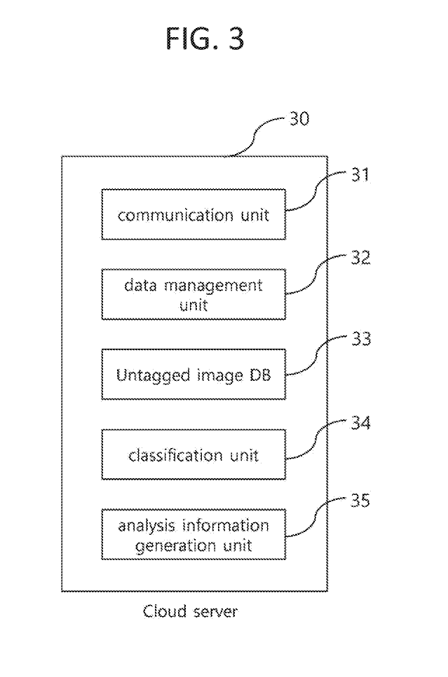

FIG. 3 is a diagram showing the internal configuration of the cloud server 30.

Referring to FIG. 3, the cloud server 30 includes a communication unit 31, a data management unit 32, an untagged image database 33, a classification unit 34, and an analysis information generation unit 35.

The communication unit 31 is responsible for a function of receiving sample image data from the client device 20 over a network and transmitting the result of analysis over the network. In this case, the communication unit 31 may receive other additional information along with the sample image data.

The data management unit 32 functions to process the sample image data and the additional information received from the client device 20 via the communication unit 31 and to manage the untagged image database 33, which will be described later. In particular, the data management unit 32 performs a process, such as a process of structuring the sample image data and the additional information into a form that can be stored in the database, and performs tasks, such as a task of storing the structured data in the untagged image database 33 and a task of searching for required data.

Meanwhile, the data management unit 32 may include a corresponding function when the preprocessing unit 22 is omitted in the client device 20, as described with reference to FIG. 2.

The untagged image database 33 stores the sample image data processed by the data management unit 32. Furthermore, the untagged image database 33 stores various types of additional information associated with the sample image data when required.

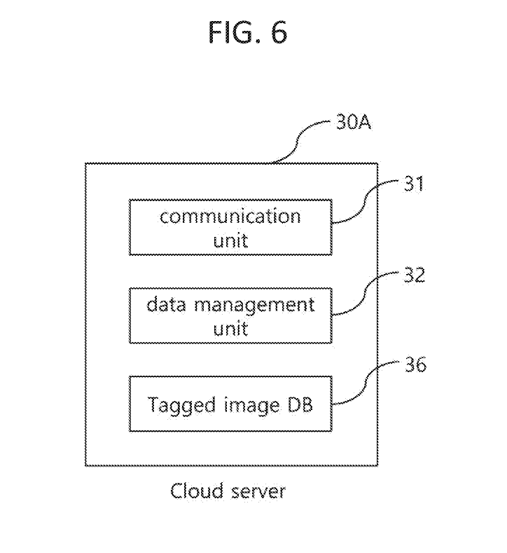

In this case, the term “untagged” means that any particular tag information has not been added, and the untagged image database is different concept from a tagged image database, which will be described below. A tagged image database 36 (see FIG. 6) refers to a database that stores image data having tag information. The tag information refers to additional information associated with the corresponding sample image data, for example, the comment of a diagnostician, classification information, information about the presence or absence of an abnormal cell, and/or the like, that is included in the database as tag information.

That is, the untagged image database 33 refers to a database that stores only the sample image data (or the sample image data and the additional information) having no particular tag information.

The classification unit 34 functions to detect an abnormality and perform classification based on the sample image data. This function refers to a function of detecting the abnormality of the tissue sample in the sample image data, classifying the abnormality according to its abnormality state, and generating classification information.

In a preferred embodiment of the present invention, the classification unit 34 may include a classification engine. The classification engine receives the sample image data, extracts a pattern or feature data from the sample image data, probabilistically predicts the result of the classification based on the extracted pattern or feature data, and outputs the result of the prediction.

For the classification engine to more accurately predict the result of the classification of arbitrary sample image data, a function of enabling the classification engine to be trained (learned) based on image data including the reliable results of classification that have been accumulated in the past (for example, tag information added by a doctor or a pathologist) is an prerequisite. The classification engine may include a feature extraction parameter adapted to extract a pattern or feature data from input data and a classification parameter adapted to predict the result of classification from an extracted pattern or extracted feature data. The above-described “training (learning)” refers to a process of searching for an appropriate feature extraction parameter and an appropriate classification parameter from image data including the reliable results of classification that have been accumulated in the past.

As an embodiment, the classification engine of the present invention is trained periodically by referring to data accumulated in the tagged image database 36 (see FIG. 6), which will be described later, through a learning method, such as an artificial neural network or Support Vector Machine (SVM) known in the conventional art, thereby it is possible to classify and determine more accurately whether the sample image data is normal.

The tagged image database 36 stores additional information as tag information, together with sample image data. In this case, the tag information refers to additional information associated with corresponding sample image data, for example, the comment of a diagnostician, classification information, information about the presence or absence of an abnormal cell, the location information of a corresponding abnormal cell, and/or the like. The classification engine may be retrained by periodically referring to data including reliable tag information accumulated in the tagged image database 36 and may be updated to the newest classification engine, so that the classification engine can more accurately generate the result of classification as the amount of data accumulated in the tagged image database 36 increases.

The tagged image database 36 stores sample image data and tag information, i.e., additional information. In this case, the tag information may include classification information as described above. The classification information represent information which can identify each piece of sample image data. For example, classification information may be in the form of class-A, class-B, and class-C.

The classification engine trains a classification parameter and a feature extraction parameter in order to extract the pattern or feature data of sample image data appearing for each class, extracts the pattern or feature data of new sample image data having no tag information based on the learned feature extraction parameter, and determines a class to which the extracted pattern or feature data belongs based on the learned classification parameter. In this case, classification is performed by calculating a probability that the extracted pattern or feature data belongs to each class and then determining a class having the highest probability.

Meanwhile, the configurations of the classification unit 34 and the classification engine are just examples and it will be apparent that another conventionally known method may be used as long as it can classify a newly input sample image by referring to a previously constructed database.

The analysis information generation unit 35 generates analysis information based on the result of the classification, obtained by the classification unit 34, and the sample image data. In this case, the analysis information (diagnosis information) may include information about whether cells included in each piece of sample image data are abnormal, the number of abnormal cells, a probability that a cell is an abnormal cell, the location information of the abnormal cell, and the comprehensive diagnosis information (information about the presence or absence of an abnormality, and the like) of each sample image. As described above, since the classification unit 34 may generate classification information by determining whether sample image data is normal and performing classification, the analysis information may include such classification information. Furthermore, information about whether cells are abnormal, the number of abnormal cells, a probability that a cell is an abnormal cell, the location information of the abnormal cell and the comprehensive diagnosis information (information about the presence or absence of an abnormality, and the like) of each sample image may be provided in a comprehensive manner based on the classification information.

An example of the operation of the classification unit 34, including the above-described classification engine, and the analysis information generation unit 35 is described as follows.

First, when sample image data is input to the classification unit 34, the classification unit 34 segments the input sample image data into a plurality of pieces of image data based on a cell nucleus appearing in an image on a predetermined size or region basis. The segmentation may be previously performed by the above-described data management unit 32.

The classification unit 34 sequentially transfers the plurality of pieces of segment image data to the classification engine. In this case, a plurality of classification engines may be provided, and the plurality of classification engines may process the plurality of pieces of segment image data in a parallel manner. In this case, the segmentation may be performed on all cell nuclei appearing in a sample image or on only a cell nucleus that is suspected of an abnormal cell.

Meanwhile, as described above, the classification engine configures a feature extraction parameter and a classification parameter through learning based on the additional information (tag information) of a previously constructed tagged image database.

The classification engine extracts a pattern or feature data from input segment image data, determines a class to which the extracted pattern or feature data belongs based on the learned classification parameter, generates the result of the determination into classification information, and outputs the classification information.

Once the above process has been performed on the overall sample image data, the classification engine generates classification information for each segment image data and outputs the classification information, and the classification unit 34 transfers a plurality of pieces of classification information to the analysis information generation unit 35 or generates a single piece of final classification information based on a plurality of pieces of classification information and transfers the final classification information to the analysis information generation unit 35.

When the classification information has been received, the analysis information generation unit 35 may generate information about whether cells are abnormal, the number of abnormal cells, a probability that the cell is an abnormal cell, the location information of the abnormal cell and the comprehensive diagnosis information (information about the presence or absence of an abnormality, and the like) of each sample image based on the corresponding classification information, as described above, and may transfer the information to the client device 20.

In this case, whether cells are abnormal may be determined based on classification information classified for each class. For example, when classes are divided into a normal class and an abnormal class, the classification engine may provide the result of classification to one of the normal and abnormal classes for input data as classification information, thereby becoming aware of whether each of the cells is abnormal.

Furthermore, the number of abnormal cells may be found by counting the number of cells classified as the abnormal class when the plurality of segment sample image data is processed by the classification engine, as described above. Furthermore, the probability that a cell is an abnormal cell may be provided based on a probability value that is used when the classification engine classifies the cell as the normal/abnormal class. The location information of an abnormal cell may be determined based on location information that is used when a cell nucleus is identified in sample image data.

Meanwhile, the analysis information generation unit 35 may determine the individual pieces of information in a comprehensive manner, and may provide information about whether the overall sample image data is abnormal as diagnosis information. For example, the sample image data is finally determined to have cancer when the number of abnormal cells within a predetermined region is equal to or larger than a predetermined number, and the result of the final determination may be provided to the client device 20 as diagnosis information.

The analysis information generated by the analysis information generation unit 35, as described above, is transferred to the client device 20 via the communication unit 31, and the client device 20 processes the received analysis information and displays the received analysis information on the display unit, thereby enabling a user to visually become aware of the analysis information, as described above.

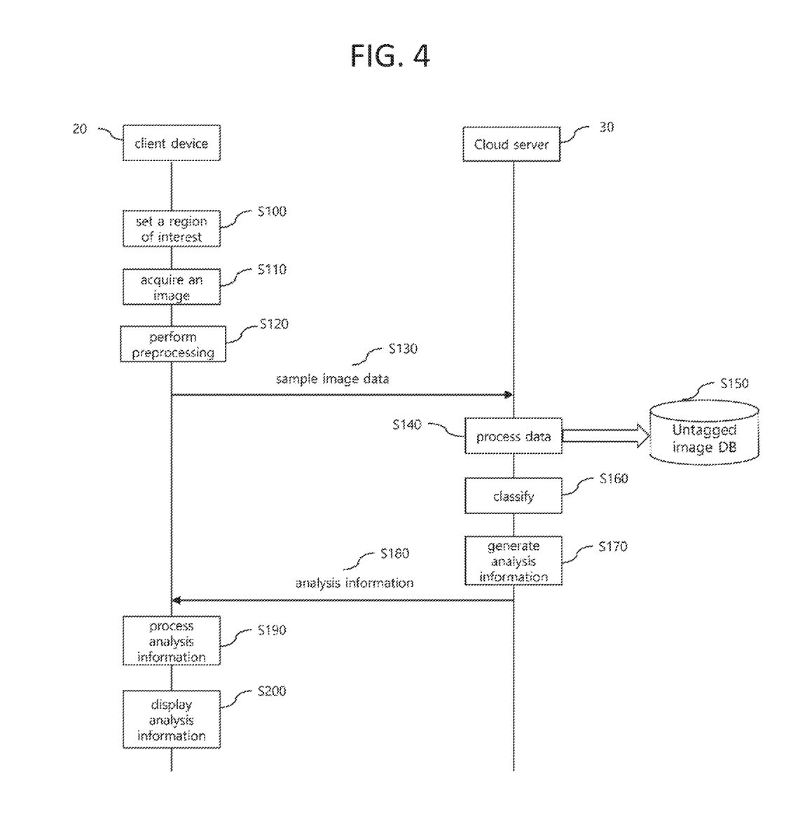

FIG. 4 is a flowchart showing an embodiment of a cloud-based pathologic analysis method that is performed in the system 100 described with reference to FIGS. 1 to 3. Referring to FIG. 4, first, a user sets a region of interest, whose image needs to be acquired, from a tissue sample by manipulating the microscope 10 at step S100.

Once the region of interest has been set, the image acquisition unit 21 of the client device 20 acquires a sample image of the region of interest at step S110.

Furthermore, at step S120, the preprocessing unit 22 performs preprocessing process on the acquired sample image when required.

Thereafter, the communication unit 23 of the client device 20 transmits the sample image data for the sample image to the cloud server 30 over a network at step S130. In this case, additional information, such as location information, for example, the coordinate information of the corresponding region of interest, may be transmitted along with the sample image data.

The communication unit 31 of the cloud server 30 receives the sample image data from the client device 20, and transfers the sample image data to the data processing unit 32. The data processing unit 32 performs a task, such as a task of structuring the received sample image data into a form that can be stored in a database, and stores the structured sample image data in the untagged image database 33 at steps S140 and S150.

Furthermore, the classification unit 34 of the cloud server 30 classifies the sample image data processed by the data processing unit 32 at step S160. This may be performed by automatically classifying the sample image data via the classification engine that has been trained based on the existing results of classification, as described above.

Once the classification has been completed, the analysis information generation unit 35 of the cloud server 30 generates analysis information based on the result of the classification, obtained by the classification unit 34, and the sample image data at step S170.

Furthermore, the analysis information generated by the analysis information generation unit 35 is transferred to the client device 20 via the communication unit 31 of the cloud server 30 at step S180.

The communication unit 24 of the client device 20 receives analysis information and transfers the analysis information to the analysis information processing unit 25, and the analysis information processing unit 25 processes the received analysis information at step S190 and provides the processed analysis information to a user by displaying the processed analysis information on the display unit at step S200, thereby enabling the user to visually become aware of the result of the analysis of the corresponding tissue sample.

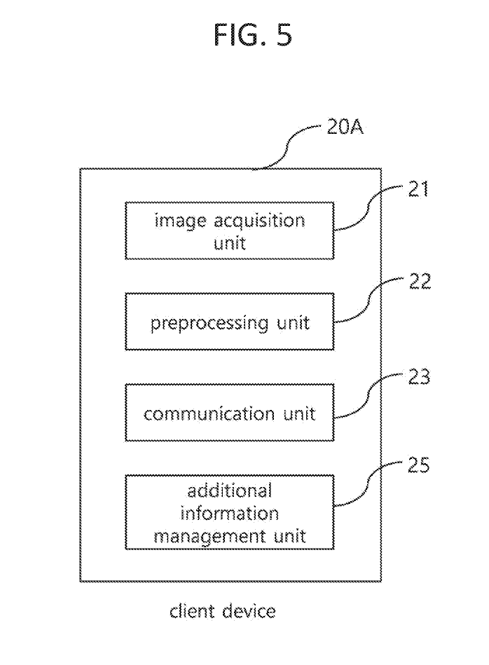

FIGS. 5 and 6 are diagrams showing another embodiment of the system 100 according to the present invention, in which FIG. 5 shows the configuration of a client device 20A and FIG. 6 shows the configuration of a cloud server 30A.

Referring to FIG. 5, the client device 20A includes an image acquisition unit 21, a preprocessing unit 22, a communication unit 23, and an additional information management unit 25.

The client device 20A of FIG. 5 is different from the client device 20 of FIG. 2 in that the analysis information processing unit 24 is excluded and the additional information management unit 25 is included instead. Since the image acquisition unit 21, preprocessing unit 22 and communication unit 23 of FIG. 5 are the same as those of FIG. 2, detailed descriptions thereof are omitted.

The additional information management unit 25 functions to receive, store and manage the additional information input by the user in connection with the sample image acquired by the image acquisition unit 21. In this case, the additional information is information input by the user (for example, a doctor, a pathologist or the like) in connection with the acquired sample image, and refers to information, such as the primary diagnosis information of the sample image that is identified by the user with the naked eye via the microscope 10 and the client device 20.

The additional information together with the sample image is stored and processed by the additional information management unit 25 of the client device 20, and is transferred to the cloud server 30A and stored in the tagged image database 36, as described above.

Meanwhile, referring to FIG. 6, the cloud server 30A includes a communication unit 31, a data management unit 32, and a tagged image database 36.

The cloud server 30A of FIG. 6 is different from the cloud server 30 of FIG. 3 in that the untagged image database 33, classification unit 34 and analysis information generation unit 35 of FIG. 3 are excluded and the tagged image database 36 is included.

Although the communication unit 31 is basically the same as the communication unit 31 of FIG. 3, the communication unit 31 is different from the communication unit 31 of FIG. 3 in that additional information together with sample image data is received from the client device 20A, as described above.

Although the data management unit 32 basically performs the same function as the data management unit 32 of FIG. 3, the data management unit 32 is different from the data management unit 32 of FIG. 3 in that the processed data further includes additional information.

The tagged image database 36 is a database that stores additional information together with sample image data. In this case, the term “tagged” means that additional information, i.e., the analysis information of the user associated with sample image data, has been “tagged.” That is, the tagged image database 36 is a database that stores “tagged” information, i.e., additional information associated with corresponding sample image data, together with sample image data, unlike the untagged image database 33 that stores only simple sample image data.

Since the cloud server 30A includes the tagged image database 36 as described above, the cloud server 30A does not need to generate analysis information and transfer the result of the generation to the client device 20, unlike the system 100 described with reference to FIGS. 1 to 4.

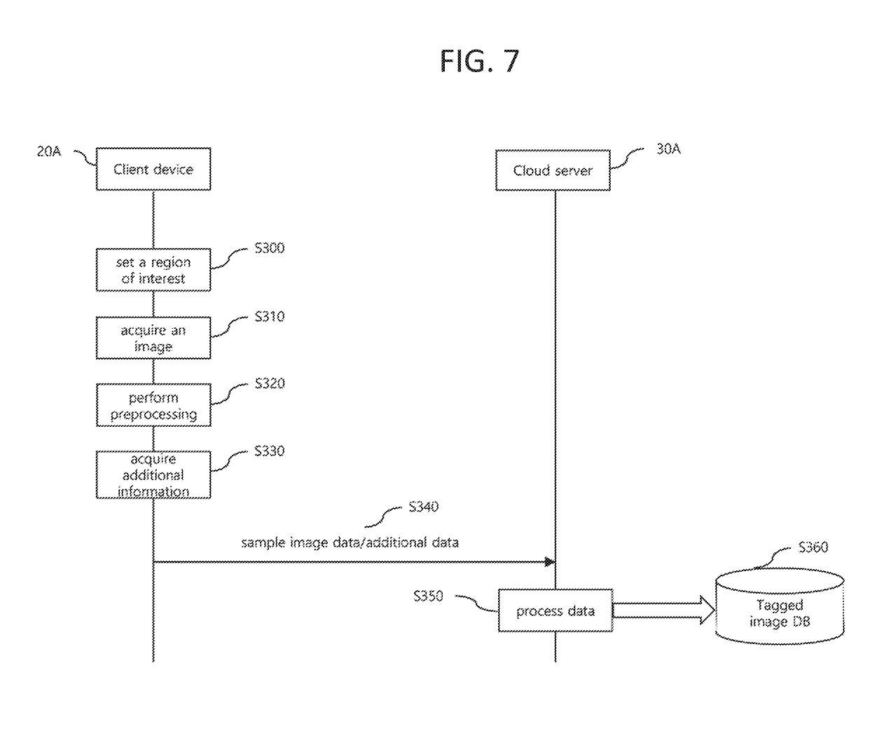

FIG. 7 is a flowchart showing an embodiment of the method that is performed in the system 100 described with reference to FIGS. 5 and 6.

Since steps S300 to S320 of FIG. 7 are the same as those of FIG. 4, detailed descriptions thereof are omitted.

In FIG. 7, step S330 is the step of acquiring additional information, and refers to the step of acquiring, by the additional information management unit 25 of the client device 20A, additional information, i.e., analysis information associated with sample image, input from the user, as described above.

Once the additional information has been acquired, the communication unit 23 of the client device 20A transmits additional information, together with sample image data, to the cloud server 30A at step S340.

The communication unit 31 of the cloud server 30A receives the sample image data and the additional information, and transfers the sample image data and the additional information to the data management unit 32. The data management unit 32 performs data processing, such as that described with reference to FIG. 4, at step S350, and stores the sample image data and the additional information in the tagged image database 36 at step S360.

The stored sample image data and additional information can be always checked through the connection of the client device 20A over a network in the future.

Meanwhile, the embodiment described with reference to FIGS. 5 to 7 is characterized in that the client device 20A acquires additional information and transmits the additional information, together with sample image data, to the cloud server 30A and in that the cloud server 30A stores the sample image data and the additional information in the tagged image database 36.

Although this embodiment may be configured to be independent of the embodiment described with reference to FIGS. 1 to 4, it is preferred that this embodiment is configured to be combined with the embodiment described with reference to FIGS. 1 to 4.

That is, it is preferred that the configuration features described with reference to FIGS. 5 to 7 are performed in addition to the features described with reference to FIGS. 1 to 4 by including the configuration of the client device 20A of FIG. 5 in the client device 20 described with reference to FIG. 2 and also including the configuration of the cloud server 30A described with reference to FIG. 6 in the configuration of the cloud server 30 described with reference to FIG. 3.

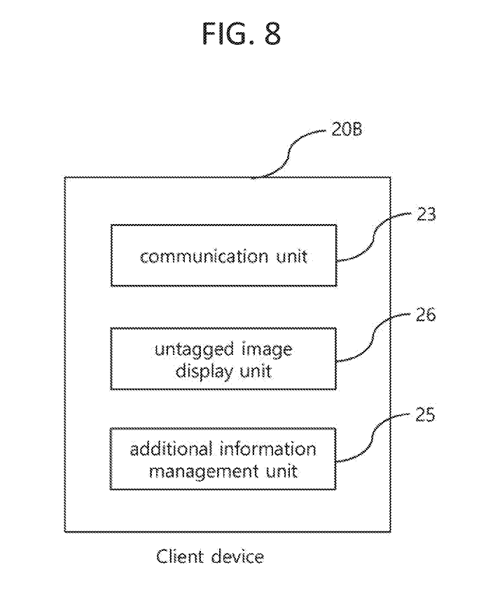

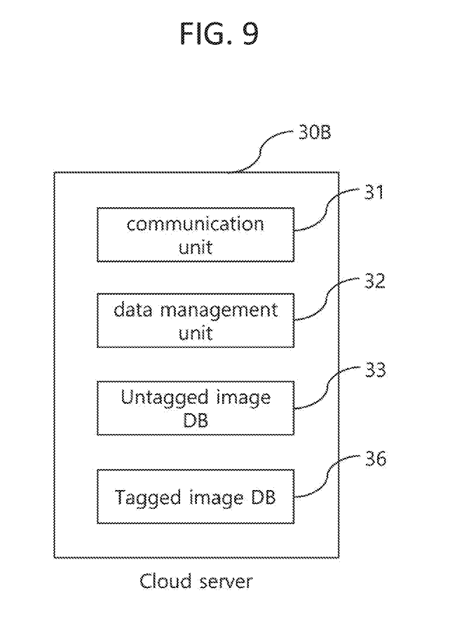

FIGS. 8 and 9 are diagrams showing still another embodiment of the system 100 according to the present invention, wherein FIG. 8 shows the configuration of a client device 20B and FIG. 9 shows the configuration of a cloud server 30B.

Referring to FIG. 8, the client device 20B includes a communication unit 23, an untagged image display unit 26, and an additional information management unit 25.

Furthermore, referring to FIG. 9, the cloud server 30B includes a communication unit 31, a data management unit 32, an untagged image database 33, and a tagged image database 36.

The system 100 including the client device 20B and the cloud server 30B is characterized in that this embodiment does not include the step of acquiring, by the client device 20B, an image, unlike the above-described embodiment.

Moreover, the system 100 of this embodiment is characterized that the client device 20B accesses the cloud server 30B, searches for sample image data untagged, i.e., having no particular additional information, in the untagged image database 33, and displays the retrieved sample image data on the display unit of the client device 20B, receives additional information input by user and transmits the input additional information, together with the ID of the sample image data, to the cloud server 30B using a method, such as that described with reference to FIGS. 7 and 8, and then the cloud server 30B adds the additional information to the sample image data corresponding to the corresponding ID and stores resulting data in the tagged image database 36.

First, the client device 20B is now described with reference to FIG. 8. The untagged image display unit 26 functions to receive sample image data having no tag information, i.e., having no particular additional information, from the untagged image database 33 of the cloud server 30B, to process the received sample image data, and to display a sample image thereof via the display.

The additional information management unit 25 functions to receive additional information from a user and then store and manage the additional information using a method, such as that described with reference to FIGS. 7 and 8, with respect to the sample image, i.e., the sample image having no tag information, which is displayed by the untagged image display unit 26.

The communication unit 23 is responsible for a function of transmitting a sample image data request signal to the cloud server 30B, receiving sample image data corresponding to the request, transferring sample image data to the untagged image display unit 26, and transmitting the identification information (ID) of the sample image data for the sample image and additional information input via the additional information management unit 25 to the cloud server 30B over a network.

Thereafter, the configuration of the cloud server 30B is now described with reference to FIG. 9. The cloud server 30B includes a communication unit 31, a data management unit 32, an untagged image database 33, and a tagged image database 36.

The communication unit 31 functions to transmit and receive data to and from the client device 20B over a network. That is, the communication unit 31 is responsible for a function of receiving the sample image data request signal from the client device 20B over the network, transmitting sample image data, retrieved when the data management unit 32 searches the untagged image database 33, to the client device 20B, and receiving the sample image data and the additional information from the client device 20B.

The data management unit 32 functions to process and manage the sample image data and the additional information and to generally manage the untagged image database 33 and the tagged image database 36.

The untagged image database 33 is a database that is configured to store sample image data having no particular additional information, as described in the above-described embodiment.

The tagged image database 36 is a database that is configured to store sample image data together with tag information, i.e., additional information.

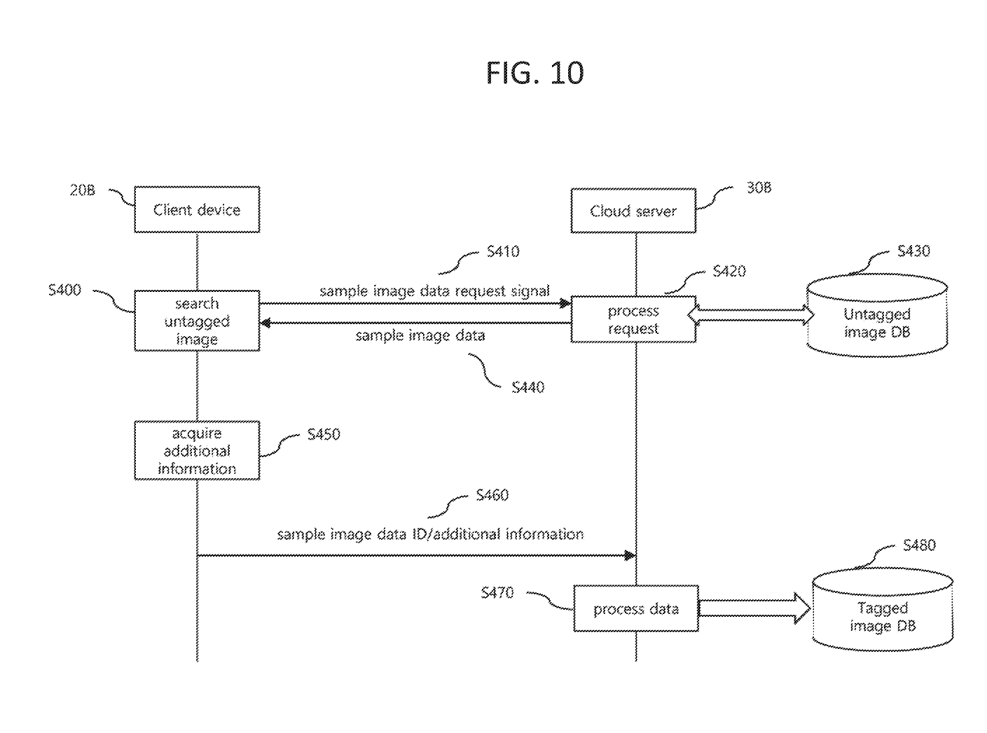

The overall operation of the system 100 having the above-described configuration is described with reference to FIG. 10.

FIG. 10 is a flowchart showing another embodiment of the method of the present invention that is performed in the system 100 of FIGS. 8 and 9.

First, the untagged image display unit 26 of the cloud server 30B accesses (logs in to) the client device 20B and transmits a sample image data request signal at steps S400 and S410.

The data management unit 32 of the cloud server 30B searches for sample image data corresponding to the received sample image data request signal in the untagged image database 33 and transmits the retrieved sample image data to the client device 20B at steps S420, S430 and S440.

The untagged image display unit 26 configures a sample image of the received sample image data and displays the sample image via the display unit and the additional information management unit 25 acquires additional information, input by a user, based on the displayed sample image at step S450.

Furthermore, the additional information and the identification information ID corresponding to the sample image data are transmitted to the cloud server 30B through the communication unit 23 of the client device 20B at step S460.

The communication unit 31 of the cloud server 30B transfers the identification information ID of the sample image data to the data management unit 32, and the data management unit 32 reads sample image data corresponding to the corresponding ID, adds the received additional information to the sample image data, and performs a process, such as a structuring process, at step S470, and stores the processed sample image data in the tagged image database at step S480.

According to the embodiment described with reference to FIGS. 8 to 10, the client device 20B searches for the sample image in a database having no tag information, and transfers additional information, such as the analysis information of the user, to the cloud server 30B as tag information, thereby enabling a tagged database to be constructed.

Accordingly, the client device 20B present at a remote location may search a database, may perform analysis, and may conveniently and efficiently add tag information, such as diagnosis information or analysis information.

Meanwhile, the embodiment described with reference to FIGS. 8 to 10 is characterized in that the client device 20B searches for sample image in a database having no tag information and transfers additional information, such as the analysis information of the user, to the cloud server 30B as tag information, thereby enabling a tagged database to be constructed. Although this embodiment may be configured to be independent of the embodiment described with reference to FIGS. 1 to 4, it is preferred that this embodiment is configured to be combined with the embodiment described with reference to FIGS. 1 to 4.

That is, it is preferred that configuration features described with reference to FIGS. 8 to 10 are performed in addition to the features described with reference to FIGS. 1 to 4 by including the configuration of the client device 20B of FIG. 8 in the client device 20 described with reference to FIG. 2 and including the configuration of the cloud server 30B of FIG. 9 in the cloud server 30 described with reference to FIG. 3.

Furthermore, as described above, the embodiment of FIGS. 5 to 7 may be configured to be combined with the embodiment of FIGS. 1 to 4, and thus the configuration of the embodiment described with reference to FIGS. 8 to 10 may be configured to be additionally combined with the former embodiment. That is, the embodiment of FIGS. 1 to 4, the embodiment of FIGS. 5 to 7 and the embodiment of FIGS. 8 to 10 may be configured to be combined with one another in an integrated manner.

Although the present invention has been described with reference to the preferred embodiments of the present invention, it will be apparent that the present invention is not limited to the embodiments.

Although the single client device has been described in the embodiments as an example, it will be apparent that two or more client devices may be provided.

Furthermore, although not described particularly in the embodiments, it will be apparent that the components of the client device may be implemented as applications (programs).

Furthermore, although the components of each of the client device 20, 20A or 20B and the cloud server 30, 30A or 30B are described as being separated from each other in the embodiments, this is provided for the purpose of functional descriptions. It will be apparent that the components may be configured to be integrated and used in accordance with the corresponding components of the embodiments.

1. A cloud-based pathological analysis system, comprising:
a client device coupled to a microscope, and configured to acquire an image for a tissue sample via the microscope and generate a sample image; and
a cloud server coupled to the client device over a network, and configured to receive sample image data from the client device over the network and store the sample image data;
wherein the cloud server analyzes the received sample image data, and transmits analysis information to the client device.

2. The cloud-based pathological analysis system of claim 1, wherein the client device comprises:
an image acquisition unit configured to acquire the sample image by acquiring the image for the tissue sample via the microscope;
a communication unit configured to transmit the sample image data for the sample image to the cloud server over the network and receive the analysis information from the cloud server; and
an analysis information processing unit configured to process the analysis information received from the cloud server and provide the processed analysis information to the user via a display unit.

3. The cloud-based pathological analysis system of claim 2, further comprising a preprocessing unit configured to perform a preprocessing process on the sample image acquired by the image acquisition unit.

4. The cloud-based pathological analysis system of claim 1, wherein the cloud server comprises:
a communication unit configured to receive the sample image data from the client device over the network and transmit a result of the analysis over the network;
a data management unit configured to process and manage the sample image data;
an untagged image database configured to store the sample image data processed by the data management unit;
a classification unit configured to determine and classify an abnormality based on the sample image data; and
an analysis information generation unit configured to generate the analysis information based on the result of the classification, obtained by the classification unit, and the sample image data.

5. The cloud-based pathological analysis system of claim 4, wherein the classification unit comprises a classification engine configured to classify the sample image data based on existing image data including results of classification.

6. A cloud-based pathological analysis method, comprising:
a first step of being coupled, by a client device, to a microscope, acquiring an image for a tissue sample via the microscope, and generating a sample image;
a second step of receiving, by a cloud server, sample image data from the client device over a network, and storing the sample image data; and
a third step of analyzing, by the cloud server, the received sample image data, and transmitting analysis information to the client device.

7. The cloud-based pathological analysis system of claim 1, wherein:
the client device further comprises an additional information management unit configured to receive additional information from a user with respect to the sample image and store and manage the additional information; and
the cloud server receives the sample image data and the additional information associated with the sample image data from the client device over the network, and stores the sample image data and the additional information.

8. The cloud-based pathological analysis system of claim 7, wherein the communication unit of the client device transmits the additional information, together with the sample image data for the sample image, to the cloud server over the network.

9. The cloud-based pathological analysis system of claim 8, wherein:
the communication unit of the cloud server receives the sample image data and the additional information from the client device over the network;
the data management unit of the cloud server processes and manages the sample image data and the additional information; and
the cloud server further comprises a tagged image database configured to store the sample image data and the additional information processed by the data management unit.

10. The cloud-based pathological analysis method of claim 6, further comprising, after the first step, a step of acquiring, by the client device, additional information associated with the sample image;
wherein the second step further comprises receiving, by the cloud server, the sample image data and the additional information associated with the sample image data from the client device over the network, and storing the sample image data and the additional information.

11. The cloud-based pathological analysis system of claim 9, wherein:
the client device receives the sample image data from the untagged image database of the cloud server, receives the additional information for the corresponding sample image data, and transmits identification information of the sample image data and the additional information to the cloud server; and
the cloud server stores the sample image data and the additional information corresponding to the identification information of the received sample image data in the tagged image database.

12. The cloud-based pathological analysis system of claim 11, wherein:
the client device further comprises:
an untagged image display unit configured to receive the sample image data from the untagged image database of the cloud server, and to display the sample image for the received sample image data via the display unit; and
an additional information management unit configured to receive the additional information from the user with respect to the displayed sample image, and to store and manage the additional information;
wherein the communication unit transmits a sample image data request signal to the cloud server, receives sample image data corresponding to the request signal, transfers the sample image data to the untagged image display unit, and transmits identification information of the sample image data for the sample image and the additional information to the cloud server over the network.

13. The cloud-based pathological analysis system of claim 11, wherein:
the communication unit of the cloud server receives a sample image data request signal from the client device over the network, transmits sample image data corresponding to the request signal, and receives identification information and additional information for the sample image data from the client device;
the data management unit of the cloud server processes the sample image data and the additional information; and
the tagged image database of the cloud server stores the sample image data and the additional information processed by the data management unit.

14. The cloud-based pathological analysis method of claim 10, further comprising steps of:
receiving, by the client device, the sample image data from the cloud server, and receiving additional information for the corresponding sample image data;
receiving, by the cloud server, identification information of the sample image data and the additional information from the client device; and
storing, by the cloud server, the sample image data and the additional information corresponding to the identification information of the received sample image data.
